(19) United States
(12) Patent Application Publication
(10) Pub. No.: US 2012/0116658 A1
(43) Pub. Date: May 10, 2012

(54) TRAFFIC INFORMATION PROVIDING SYSTEM AND TERMINAL AND METHOD OF PROVIDING TRAFFIC INFORMATION USING THE SAME

(75) Inventors: Bum Tae Lee, Goyang (KR); Sung Wook Heo, Yongin (KR); Chi Nam Oh, Suwon (KR); Min Suk Kim, Yongin (KR); Young Eon Ma, Ulsan (KR)

(73) Assignees: KIA MOTORS CORPORATION, Seoul (KR); HYUNDAI MOTOR COMPANY, Seoul (KR)

(21) Appl. No.: 13/069,935

(22) Filed: Mar. 23, 2011

(30) Foreign Application Priority Data
Nov. 9, 2010 (KR) 10-2010-0111057

(51) Int. Cl. G08G 1/00; G01C 21/36

(52) U.S. Cl. 701/117

(57) ABSTRACT

The present invention provides a traffic information providing system and terminal and a method of providing traffic information. More specifically, the traffic information providing system includes a first module, within a vehicle, which is configured to receive a range associated with a route calculated by a terminal from a web server, wherein a plurality of ranges are previously set based on a traveling route, a specific region and a present position. Additionally the present invention also includes a second module that is configured to receive a traffic information request for any one of a plurality of ranges from the terminal via a command. A third module is configured to collect traffic information within the provided range corresponding to the command. Upon doing so the second module transmits the traffic information collected by the third module to the traffic information providing terminal to be conveyed to the driver.

### CROSS-REFERENCES TO RELATED APPLICATIONS

Priority is claimed to Korean patent application number 10-2010-0111057, filed on Nov. 9, 2010, the entire contents of which application is incorporated herein for all purposes by this reference.

### BACKGROUND OF THE INVENTION

1. Field of the Invention

The present invention relates to traffic information providing system and terminal for providing traffic information such as road traffic condition information, accident information and the like to a user, and a method of providing traffic information using the same.

2. Description of the Related Art

Navigation systems provide a travelling route from a starting point to a destination. The prior navigation systems collectively receive traffic information of all roads at a constant time interval from a traffic information server, extract traffic information on a traveling route demanded by a user from the traffic information of the all roads, and provide the extracted traffic information to the user.

Since the prior navigation systems receive the traffic information of the all roads, they have an ineffective data communication procedure.

In addition, the prior navigation systems provide only information such as a degree of a traffic jam and a car accident on a traveling route (for example, a suggestion path, the shortest path, a free path, a fast path, and the like) from a starting point to a destination demanded by a user, but they do not actually provide video of vehicle jam and a car accident on the corresponding traveling route.

Accordingly, the information disclosed in this Background section is only for enhancement of understanding of the general background of the invention and should not be taken as an acknowledgement or any form of suggestion that this information forms the prior art already known to a person skilled in the art.

### SUMMARY OF THE INVENTION

Various aspects of the present invention have been made in view of the above problems associated with conventional navigation systems, and provide a traffic information system and a terminal and a method of providing traffic information using the same, which allows a user to register at least one or more setting distances on a web server in advance as traffic information providing ranges on the basis of a traveling route, a specific region, and a present position. The traffic information system may also be configured to collect traffic information corresponding to the specific traffic information providing range requested through a command, e.g., voice command from the traffic information providing range previously registered on the web server, and provides the collected traffic information to the traffic information providing terminal of the user.

For example, in one embodiment of the present invention, the traffic information providing system includes a communication module which receives a traffic information providing range for a corresponding traffic information providing terminal from a web server in which traffic information providing ranges are previously set on the basis of a traveling route, a specific region and a present position. The traffic information providing system also includes a control module which receives a traffic information request for any one of the traffic information providing ranges from the traffic information providing terminal through a command, e.g., voice command, and a traffic information collection module which collects traffic information in a traffic information providing range corresponding to the command, e.g., voice command. In doing so, control module transmits the traffic information collected by the traffic information collection module to the traffic information providing terminal.

According to an aspect of the present invention, the traffic information terminal may include a key input module which inputs at least one or more setting distances as traffic information providing ranges on the basis of a traveling route, a specific region and a present position. Additionally the terminal may also include a data processing module which registers the traffic information providing ranges input from the key input module on a web server, requests traffic information for a corresponding traffic information providing range to a traffic information providing system if a traffic information request for an arbitrary traffic information providing range is received from a user through a command, e.g., voice command, and receives corresponding traffic information from the traffic information providing system. Furthermore, a route providing module may also be utilized which provides traffic information transmitted from the data processing module to the user.

Additionally, the present invention also provides a method for providing traffic information to a vehicles navigation system. The method includes (a) receiving a traffic information providing range for a corresponding traffic information providing terminal from a web server on which at least one or more traffic information providing ranges on the basis of a traveling route, a specific region and a present position in a unit of a traffic information providing terminal, (b) receiving a traffic information request in an arbitrary traffic information providing range from the traffic information providing terminal through an engaged command, e.g., voice command, (c) collecting traffic information in the traffic information providing range corresponding to the command, e.g., voice command transmitted, and (d) transmitting collected traffic information to the corresponding traffic information providing terminal.

Advantageously, the present invention does not require the system to collect traffic information for all roads but rather collects only traffic information corresponding to a corresponding traffic information providing range requested through the command, e.g., voice command from the traffic information providing terminal thereby drastically reducing the amounts of data transmission and data collection.

In addition, the present invention may also be configured to provide traffic jam and accident information occurring on the travelling route as well as a video of the vehicle traffic jam and the traffic accident respectively in order to help a user drive to his destination in the most efficient manner.

The methods, terminals and systems of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

The objects, features and advantages of the present invention will be more apparent from the following detailed description in conjunction with the accompanying drawings, in which:

FIG. 1 is a diagram illustrating the whole configuration of an exemplary traffic information providing network according to an exemplary embodiment of the present invention.

FIG. 2 is a diagram illustrating a configuration of an exemplary web server according to an exemplary embodiment of the present invention.

FIG. 3 is a diagram illustrating a configuration of an exemplary traffic information providing terminal according to an exemplary embodiment of the present invention.

FIG. 4 is a diagram illustrating a configuration of an exemplary traffic information providing system according to an exemplary embodiment of the present invention.

FIG. 5 is a diagram illustrating a configuration of an exemplary command, e.g., voice command recognition server according to an exemplary embodiment of the present invention.

FIG. 6 is a flow chart illustrating a method of providing traffic information using a traffic information providing network according to an exemplary embodiment of the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

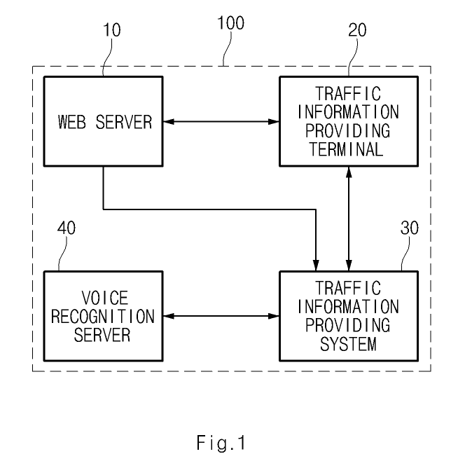

FIG. 1 is a diagram illustrating the whole configuration of an exemplary traffic information providing network 100 according to the present invention. As shown in FIG. 1, the traffic information providing network according to the present invention includes a web server 10, traffic information providing terminal 20, a traffic information providing system 30 and a voice recognition server 40.

The web server 10 provides a registration environment in order to allow a user of the traffic information providing terminal 20 to register at least one or more setting distances as traffic information providing ranges in advance on the basis of a travelling route of which traffic information is to be provided to a user, a specific region, and a present position.

The traffic information providing terminal 20 accesses to the web server 10 and registers the at least one or more setting distances as the traffic information providing ranges on the web server 10 on the basis of a travelling route, a specific region, and a present position. That is, the traffic information providing terminal 20 accesses to the web server 10 and registers at least one or more traffic information providing ranges on the web server 10 on the basis of the travelling route, the specific region, and the present.

In response a request for traffic information corresponding to an arbitrary traffic information providing range from a user through a command, e.g., voice command, the traffic information providing terminal 20 is configured to request traffic information corresponding to a corresponding traffic information providing range be sent to a traffic information providing system 30.

The traffic information providing terminal 20 receives the traffic information corresponding to corresponding traffic information providing range from the traffic information providing system 30 and provides the traffic information to the user.

The traffic information providing system 30 receives a traffic information providing range for the traffic information providing terminal 20 from the web server 10 and receives a traffic information request for any one of the traffic information providing ranges from the traffic information providing terminal 20 through an engaged command, e.g., a voice command.

The traffic information providing system 30 is also configured to collect traffic information for a traffic information providing range corresponding to a command, e.g., voice command and transmits the collected traffic information to the traffic information providing terminal 20.

The voice recognition server 40 recognizes a voice command transmitted from the traffic information providing terminal 20 and provides the recognized result to the traffic information providing terminal 20.

Components of the traffic information providing network 100 according to the present invention are described in further detail below.

### Configuration of the Web Server 10

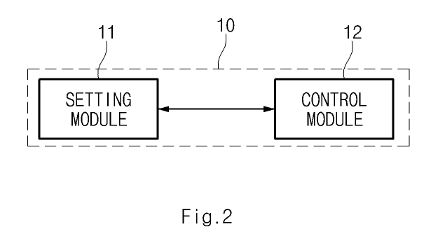

FIG. 2 is a diagram illustrating a configuration of the web server 10 according to an exemplary embodiment of the present invention.

As illustrated in FIG. 2, the web server 10 includes a setting module 11 and a control module 12.

The setting module 11 accesses the traffic information providing terminal 20, through a conventional procedure of member joining and log-in, provides a web page environment capable of setting traffic information providing ranges on the basis of a travelling route and a specific region to the traffic information providing terminal 20. That is, the setting module 11 provides an interface capable of searching the travelling route from a starting point to a destination and an interface capable of searching an address of the specific region.

The setting module 11 allows a user of the traffic information providing terminal 20 to input at least one or more traveling routes. If the user of the traffic information providing terminal 20 inputs more than one travelling route, the setting module 11 allows the user to register an engaged voice command for selecting a corresponding travelling route such as “a route to home” and “a route to the company” to be associated with the travelling routes.

A setting distance (for example, 5 miles) at the present position of the traffic information providing terminal 20 may be set in the setting module 11 as the traffic information providing range. In this case, the setting module 11 allows the user of the traffic information providing terminal 20 to register the voice command (for example, “surrounding information”, etc.) for selecting the traffic information providing range.

The control module 12 in the present invention maybe configured to provide the traffic information providing range set by the traffic information providing terminal 20 in association with the traffic information providing system 30 to the traffic information providing system 30. Accordingly, the user of the traffic information providing terminal 20, which will be described later, receives the corresponding traffic information from the traffic information providing system 30 through e.g., a voice command.

### Configuration of the Traffic Information Providing Terminal 20

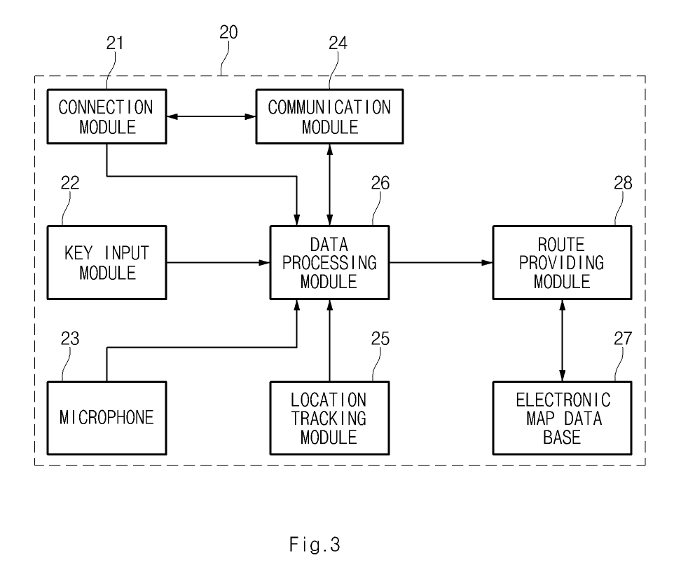

FIG. 3 is a diagram illustrating a configuration of the traffic information providing terminal 20 according to an exemplary embodiment of the present invention. As shown in FIG. 3, the traffic information providing terminal 20 may be embodied by a navigation terminal, a mobile communication terminal, or the like. The traffic information providing terminal 20 includes a connection module 21, a key input module 22, a microphone 23, a communication module 24, a location tracking module 25, a data processing module 26, an electronic map data base 27 and a route providing module 28.

The connection module 21 accesses the web server 10 using a predefined communication protocol to communicate with the web server 10.

The key input module 22 inputs at least one or more setting distances as the traffic information providing range on the basis of a travelling route of which traffic information is to be provided to a user, a specific region and a present position if an environment capable of setting the traffic information providing ranges is provided from the setting module 11 of the web server 10. The key input module 22 may also input texts for the voice command corresponding to the respective traffic information proving ranges.

The microphone 23 receives the engaged voice of the user corresponding to the traffic information providing range from the user.

The communication module 24 communicates with the traffic information providing system 30 using the predefined communication protocol.

The location tracking module 25 may be embodied by a global positioning system (GPS) receiver, etc. and configured to locate a present position of the traffic information providing terminal 20.

The data processing module 26 transmits the voice command corresponding to the traffic information providing range input from the key input module 22 and the present position of the traffic information providing terminal 20 to the traffic information providing system 30 through the communication module 24. The data processing module 26 receives the traffic information corresponding to the traffic information providing range from the traffic information providing system 30.

Here, the traffic information includes traffic condition information, traffic condition videos and traffic accident videos. That is, the traffic condition may be traffic condition information (traffic jam, traffic smoothness, traffic delay) within a setting distance (traffic information providing range) on the basis of a travelling route, a specific region and a present position of a vehicle. The traffic condition video may be a video representing a travelling condition of vehicles on roads within the setting distance on the basis of the travelling route, the specific region and the present position of the vehicle. The traffic accident video may be a video of a traffic accident caused within the setting distance on the basis of the travelling route, the specific region and the present position of the vehicle.

The electronic map data base 27 may be constructed of an electronic map including a kind of guide information, geographic information and the like.

The route providing module 28 provides the transmitted traffic information to user and route searching information for the travelling route using the traffic information. That is, the route providing module 28 suggests a travelling route with less traffic using the traffic condition information included in the traffic information or informs the user of an estimated time of arrival, a degree of traffic congestion, or the like through the traffic condition information of the travelling route.

Alternatively, the route providing module 28 may provide traffic information within the setting distance on the basis of a specific region and/or a present position to a user. For example, if the place set by the user is around 123 Yeoksam-dong Kangnam-ku, Seoul, the route providing module 28 may provide traffic information for various kinds of roads existing around 123 Yeoksam-dong Kangnam-ku, Seoul to a user.

On the other hand, the route providing module 28 may also provide a travelling route located in the corresponding event and bypass route searching information for a specific region if event information from the traffic information providing system 30 is received.

### Configuration of the Traffic Information Providing System 30

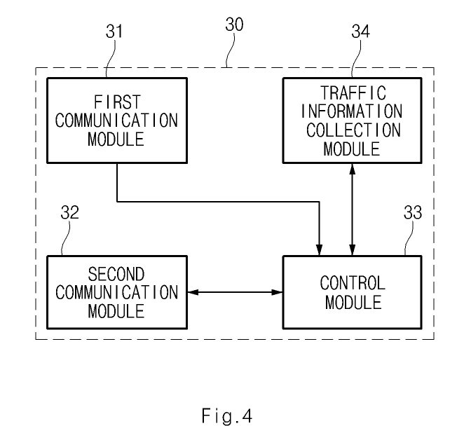

FIG. 4 is a diagram illustrating a configuration of the traffic information providing system 30 according to the present invention. As shown in FIG. 4, the traffic information providing system 30 includes a first communication module 31, a second communication module 32, a control module 33 and a traffic information collection module 34.

More specifically, the first communication module 31 communicates with the web server 10 using the predefined communication protocol. The second communication module 32, on the other hand, communicates with the traffic information providing terminal 20 using its predefined communication protocol.

The control module 33 receives at least one or more setting distances as traffic information providing ranges on the basis of a travelling route for the traffic information providing terminal 20, a specific region and a present position from the web server 10 using the first communication module 31. Here, the control module 33 further receives reference commands, e.g., voice commands for the traffic information providing ranges from the web server 10 through the first communication module 31.

The control module 33 also receives a traffic information request for any one of the traffic information providing ranges from the traffic information providing terminal 20 through the second communication module 32 through a command, e.g., a voice. When the command is a voice command, the voice command received from the traffic information providing terminal 20 is transmitted, by the control module, to the voice recognition server 40. In response, the voice recognition sends recognition information for the voice command back to the control module 33.

The traffic information collection module 34 may be in communication with a server that is associated external traffic information collection facilities or embodied by traffic information collection facilities. Accordingly, the traffic information collection module 34 selectively collects traffic information on the basis of the traffic information providing range corresponding to the, e.g., voice command.

Furthermore, the control module 12 may transmit traffic information for the traffic information providing range collected by the traffic information collection module 34 to the traffic information providing terminal 20.

Additionally, the traffic information collection module 34 may further collect corresponding event information together with the traffic information if there is specific event (e.g., the World cup, summit conference, road closure, or construction) within the traffic information providing range. Thus, the route providing module 28 may identify a travelling route in which the corresponding event is located and provide bypass route searching information for a specific region.

### Configuration of Voice Recognition Server 40

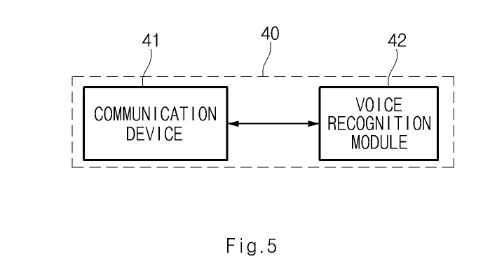

FIG. 5 is a diagram illustrating a configuration of the exemplary voice recognition server 40 according to an exemplary embodiment of the present invention. As shown in FIG. 5, the voice recognition server 40 includes a communication device 41 and a voice recognition module 42.

The communication device 41 is configured to communicate with the traffic information providing system 30 using the predefined communication protocol. As stated above, the voice recognition server 40 also includes a voice recognition module 42 which may be configured to receive a command or voice command from the traffic information providing system 30 through the communication device 41. The voice recognition module 42 recognizes the user's voice, and transmits the recognition result to the traffic information providing system 30 in the form of text. In doing so, the voice recognition module 42 receives and stores reference user voice commands for the respective traffic information providing ranges in advance.

Furthermore, a method of providing traffic information using the traffic information providing network 100 according to the present invention is described below.

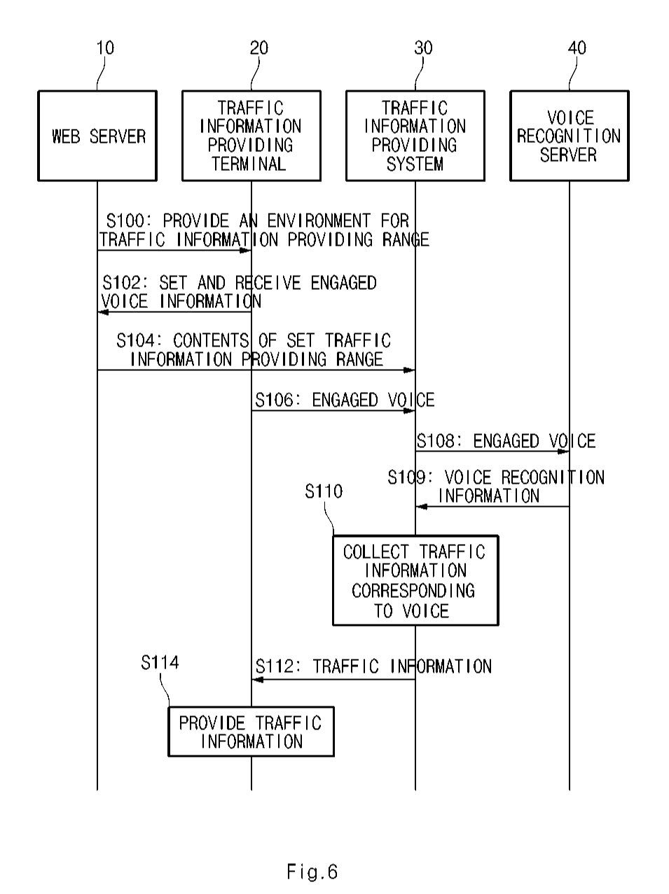

FIG. 6 is a flowchart illustrating a method of providing traffic information using the traffic information providing network 100 according to an exemplary embodiment of the present invention.

First, the setting module 11 of the web server accesses the traffic information providing terminal 20 through, for example, a conventional procedure of member joining and log-in and provides an environment capable of setting traffic information providing ranges to the traffic information providing terminal 20 (S100).

Subsequently, the traffic information providing ranges and engaged voices/voice commands corresponding to the traffic information providing ranges are set in the setting module 11 of the web server 10 by the traffic information providing terminal (S102).

Next, the control module 12 of the web server 10 transmits the traffic information providing ranges set by the traffic information providing terminal 20 to the traffic information providing system 30 (S104).

If traffic information for any one of the traffic information providing ranges is requested by a command or voice, the data processing module 26 of the traffic information providing terminal 20 transmits a corresponding command or voice command to the traffic information providing system 30 (S106).

Then, in some embodiments of the present invention in which a voice command is received, the control module 33 of the traffic information providing system 30 transmits the engaged voice or voice command to the voice recognition server 40 (S108) and receives recognition information for the voice from the voice recognition server 40 (S109).

The traffic information collection module 34 of the traffic information providing system 30 then collects traffic information in the traffic information providing range corresponding to the command or voice command (S110). The control module 33 of the traffic information providing system 30 may then transmit the collected traffic information to the traffic information providing terminal 20 (S112).

Finally, the route providing module 28 of the traffic information providing terminal 20 provides the transmitted traffic information to a user or route searching information for the travelling route using the traffic information (S114).

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A traffic information providing system, the system comprising:
a communication module which receives a traffic information providing range for a corresponding traffic information providing terminal from a web server in which traffic information providing ranges are previously set on the basis of a traveling route, a specific region and a present position;
a control module which receives a traffic information request for any one of the traffic information providing ranges from the traffic information providing terminal through a voice; and
a traffic information collection module which collects traffic information in the traffic information providing range corresponding to the voice,
wherein the control module transmits the traffic information collected by the traffic information collection module to the traffic information providing terminal.

2. The system according to claim 1, wherein the communication module receives the traffic information providing range for the traffic information providing terminal and a reference voice corresponding to the traffic information providing range from the web server.

3. The system according to claim 1, wherein the traffic information includes at least one or more of traffic condition information, a traffic condition video and a traffic accident video.

4. The system according to claim 1, wherein the control module transmits the voice received from the traffic information providing terminal to a voice recognition server and receives recognition information for the voice from the voice recognition server.

5. The system according to claim 1, wherein the control module further receives a present position of the traffic information providing terminal from the traffic information providing terminal.

6. The system according to claim 1, wherein the traffic information collection module collects event information for the at least one or more traffic information providing ranges and the control module transmits the event information to the traffic information providing terminal and allows the traffic information providing terminal to provide searching information of a bypass route for a section in which the event information is generated.

7. A traffic information providing terminal, the terminal comprising:
a key input module which inputs at least one or more setting distances as traffic information providing ranges on the basis of a traveling route, a specific region and a present position;
a data processing module which registers the traffic information providing range input from the key input module on a web server, request traffic information for a corresponding traffic information providing range to a traffic information providing system if a traffic information request for an arbitrary traffic information providing range is received from a user through a voice, and receives corresponding traffic information from the traffic information providing system; and
a route providing module which provides the traffic information transmitted from the data processing module to the user.

8. The terminal according to claim 7, wherein the key input module further receives texts for voices corresponding to the traffic information providing ranges.

9. The terminal according to claim 7, wherein the traffic information includes at least one or more of a traffic condition information, a traffic condition video and a traffic accident video.

10. The terminal according to claim 7, further comprising a microphone which inputs the traffic information request in the arbitrary traffic information providing range through the voice from the user,
wherein the data processing module transmits the voice input through the microphone to the traffic information providing system.

11. The terminal according to claim 7, wherein the data processing module further receives event information in the arbitrary traffic information providing range from the traffic information providing system, and the route providing module provides bypass route searching information for a section in which the event information is generated.

12. A method of providing traffic information, the method comprising:
(a) receiving a traffic information providing range for a corresponding traffic information providing terminal from a web server in which at least one or more traffic information providing ranges on the basis of a traveling route, a specific region, a present position in a unit of a traffic information providing terminal;
(b) receiving a traffic information request in an arbitrary traffic information providing range from the traffic information providing terminal through a voice;
(c) collecting traffic information in the traffic information providing corresponding to the voice transmitted; and
(d) transmitting collected traffic information to the corresponding traffic information providing terminal.

13. The method according to claim 12, wherein the (a) receiving a traffic information providing range includes further receiving a reference voice corresponding to the traffic information providing range.

14. The method according to claim 12, wherein the (b) receiving a traffic information request includes:
transmitting the voice received from the traffic information providing terminal; and
receiving recognition information for the voice from a voice recognition server.

15. The method according to claim 12, wherein the (C) receiving a traffic information request includes further receiving a present position of the traffic information providing terminal from the traffic information providing terminal.

16. A traffic information providing system, the system comprising:
a first module within a vehicle configured to receive a range associated with a route calculated by a terminal from a web server, wherein a plurality of ranges are previously set based on a traveling route, a specific region and a present position;
a second module, within the vehicle, configured to receive a traffic information request for any one of the ranges from the terminal via a command; and
a third module which collects traffic information within the range corresponding to the command,
wherein the second module transmits the traffic information collected by the third module to the traffic information providing terminal.
